(19) United States
(12) Patent Application Publication
(10) Pub. No.: US 2024/0090472 A1
(43) Pub. Date: Mar. 21, 2024

(54) ANIMAL INFORMATION MANAGEMENT SYSTEM & METHOD OF USE THEREOF

(71) Applicant: Tracy A Bishop, Montrose, CO (US)

(72) Inventor: Tracy A Bishop, Montrose, CO (US)

(21) Appl. No.: 17/947,112

(22) Filed: Sep. 17, 2022

(51) Int. Cl. A01K 11/00; A01K 29/00; G06K 7/14

(52) U.S. Cl. CPC A01K 11/006; A01K 29/005; G06K 7/1417

(57) ABSTRACT

An animal information management system & method of use thereof which generally comprises a physical main tag body, and computer related software, software programming language and code, including computer based applications, internet web page based code, and methods of applications for providing the user with a method and process to facilitate and manage the various tasks associated with accumulating, correlating, organizing, saving, storing, retrieving, and disseminating or communicating digital information across dissimilar digital computing platforms, software applications, or communications devices, that will further provide a user with current, vital, and relevant information and data pertaining to the identity, health, location, owner, diet, feeding schedule, care to be given, prescriptions, vaccines, emergency contacts, and other generally relevant information related to a pet or subject animal, by way of QR code scan, NFC tag sensing, image recognition scan, barcode scan, or snaptag image barcode scan from a mobile or handheld device.

### CROSS REFERENCE TO RELATED APPLICATION

This application claims priority to U.S. provisional application No. 63/245,447 filed Sep. 17, 2021, the entirety of which is included herein for reference.

### FIELD OF THE INVENTION

This invention generally relates to the field of information management applications and methods of use thereof. Moreover, it pertains specifically to a new animal identification and information management system & method of use that will allow users to document, store, retrieve, and communicate animal related information from a multitude of sources in a seamless and continuous workflow process.

### BACKGROUND

It is well understood that pets are limited in their ability to protect and continually care for themselves. Pets of every species require the ongoing attention, effort, and care from their owners to ensure a safe and healthy life. Part of being a pet owner is to provide the best life possible for their pets by providing vaccines, general medical care, physical grooming, special diet and care accommodations based on age progression, as well as, providing their pets a safe and nurturing environment to live; such as, housing, fenced/restricted yard dwelling, and shelter from all types of adverse weather conditions.

In a typical pet's life, there are very specific pieces of data and information related to the pet including the pet's name, age, home address, allergies, medicines, vaccines, veterinary contacts, surgeries, owner's name, owner's contact information, chip information, emergency contacts, and more which are each known to select individuals. This typically means that while a few select individuals have access to some, or even most of the data and information, everyone else has minimal or no access to that data and information.

In a “time constraint event”, or an emergency where time is of utmost importance, it is critical to convey vital, relevant data and information to the people who need it in the emergency moment. Most pets wear collars, and most pets with collars have a pet tag of some type, typically made of plastic or metal that are affixed or otherwise attached to the pet's collar.

While the aforementioned prior art, or existing, pet tags can contain some of the above listed information, which can be helpful in both emergency and non-emergency events such as hit by car, pet bites, and lost pets, however that information contained on the pet tags very often changes over time. This often results in the pet wearing a tag with outdated data and information that can have an unintended harmful or even catastrophic impact during an emergency event.

There is therefore a need for a new pet data and information system, such as the one disclosed herein as the present invention, that allows a pet owner to upload, or otherwise enter, and continually update pet specific data and information, and also allow read-only access to anyone who happens to find themselves in an emergency event involving the pet, in the most efficient and time sensitive manner.

### SUMMARY

The terms “invention”, “this invention”, and “the present invention” used in this patent are intended to refer broadly to all of the subject matter of this patent and the patent claims below. Statements containing these terms should be understood not to limit the subject matter described herein or to limit the meaning or scope of the patent claims below.

The term “a” or “an” entity, as used herein, refers to one or more of that entity. As such, the terms “a” (or “an”), “one or more” and “at least one” can be used interchangeably herein. The use of “including,” “comprising,” or “having,” and variations thereof, is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials, or acts, and the equivalents thereof, shall include all those described in the summary of the invention, brief description of the drawings, detailed description, abstract, and claims themselves.

Embodiments of the invention covered by this patent are defined by the claims below, not this summary. This summary is a high-level overview of the various aspects of the invention and introduces some of the concepts that are further described as the Detailed Description section below. This summary is not intended to identify key or essential features of the claimed subject matter, nor is ti intended to be used in isolation to determine the scope of the claimed subject matter. The subject matter should be understood by reference to appropriate portions of the entire specification of this patent, any or all drawings and each claim.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present disclosure.

Moreover, references made herein to “the present invention” or aspects thereof should be understood to mean certain embodiments of the present disclosure and should not necessarily be construed as limiting all embodiments to a particular description.

The present disclosure is set forth in various levels of detail in the Summary of the Invention as well as in the attached drawings and Detailed Description and no limitation as to the scope of the present disclosure is intended by either the inclusion or non-inclusion of elements, components, etc. in this Summary of the Invention. Additional aspects of the present disclosure will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below. Further details and other features will become apparent after review of the following Detailed Description and accompanying drawing figures.

In view of the limitations now present in the prior art, the present invention provides a new and useful animal information management system & method of use thereof which is simpler in use, more universally functional, and more versatile in operation than known applications of this kind.

### DETAILED DESCRIPTION

The purpose of the present invention is to provide a new animal information management system & method of use that will allow users to accumulate, correlate, and communicate information from a multitude of sources in a seamless and continuous workflow process, then convey that data and information to relevant individuals during a “time constraint”, or emergency event by use of digital scanning technology. It is also a purpose of the present invention to provide a new animal information management system & method of use thereof which has many novel features not offered by prior art applications resulting in a new animal information management system & method of use not anticipated either directly or indirectly by any prior art applications.

The present invention in the preferred embodiment generally comprises a physical main tag body 10, a main tag body attachment hole 15, and computer related software, software programming language and code, including computer based applications, internet web page based code, and methods of applications for providing the user with a method and process to facilitate and manage the various tasks associated with accumulating, correlating, organizing, saving, storing, retrieving, and disseminating or communicating digital information across dissimilar digital computing platforms, software applications, or communications devices, that will provide a user with current, vital, and relevant information and data pertaining to the identity, health, location, owner, care to be given, and emergency contacts, as well as other information and data not referred to herein which is considered apparent and obvious to the disclosure.

The present invention, in the preferred embodiment, embodies a quick response “QR” code 20, in, and visible on, the main tag body 10. The main tag body is to be worn or removably attached to the collar 11 of a pet, or subject animal be inserting a ring 16 or similar fastener through the main tag body attachment hole 15. The QR code 20 embodied in the main tag body 10 is read, scanned, or otherwise interacted with, thereby providing the person who is performing the QR code read, or scan, herein referred to as the “access person”, with current, vital, and relevant information and data 30 pertaining to the identity, health, location, owner, care to be given, and or emergency contacts, as well as other information of the pet or subject animal.

It is anticipated that the data and information 30 conveyed from the main body tag of the pet or subject animal, to the access person by means of the QR code scan, can be instantly presented to them in a variety of ways including as a readable PDF, as a webpage, as digital audio, as a text or SMS message, or other manner not referred to herein that performs the same purpose and function for providing a useful and helpful method of ensuring that proper care is given to the pet or subject animal, in the form of medication and or medical treatment or procedures.

It is intended that the present invention disclosed herein, in the preferred embodiment, allow a primary user, or primary user representative, to upload or enter pet related data and information, into a main services webpage, website, application (APP) page, database, data form or server, with the use of virtually any software application interface, including but not limited in use to, internet application or APP based text entry fields, internet based webforms, Microsoft Word, Pages, Notepad, WordPad, Notes, Google DOCS, Adobe, PDF Reader, and other similar software applications that accomplish the same purpose and function, in a manner that will allow a primary user to selectively accumulate, enter, store, filter, access, edit and otherwise manage information related to a pet or animal for the purpose of generating a pet identification tag to be worn or otherwise affixed to a pet or animal, thereby allowing the primary user, or an undetermined secondary user to quickly access pet related data and information from a remote location removed from the actual main services website, data server, database, or other digital file, data or information repository not referred to herein that performs the same purpose and function and is to be considered apparent and obvious to the disclosure contained herein, whereby the pet related data and information will provide said users with relevant, vital, actionable information pertaining to the identity, health, location, owner, care to be given, and emergency contacts of the pet.

It is further intended that the method of remotely scanning a QR code 20 embodied in the main tag body 10, to access the pet related data and information 30, can also be accomplished with similar technologies that accomplish the same purpose and function and are therefore to be considered apparent and obvious to the disclosure contained herein. These anticipated technologies include but are not limited to, Near-Field Communication (NFC) tags, Image Recognition, Barcode, and SnapTag Barcode Imagery. Near-Field Communication (NFC) tags utilize technology available on most smart phones devices and rely on proximity sensing between the device and the tag to trigger or initiate the programmed action such as initiating the opening of a webpage, APP, stored document, or similar interface that provides the user with the relevant data and information. Image Recognition scanning technology may also be used from a smartphone or other handheld device to scan the tag, which in this instance may comprise a customer or pet specific image 40, which when scanned will trigger or initiate the programmed action such as initiating the opening of a webpage, APP, stored document, or similar interface that provides the user with the relevant data and information. Barcode scanning technology may also be embodied in the present invention to trigger or initiate the programmed action such as initiating the opening of a webpage, APP, stored document, or similar interface that provides the user with the relevant data and information upon scanning. SnapTag Barcode Imagery can further be used to turn any customer or pet specific image into a barcode that when scanned will trigger or initiate the programmed action such as initiating the opening of a webpage, APP, stored document, or similar interface that provides the user with the relevant data and information.

It is to be understood that the main tag body 10 and related QR code 20, NFC tag, Image recognition scan, barcode scan, snaptag scan, or similar specific data and information identifying and conveyance method or technology, can be embodied as an epoxy resin ID 50, collar embedded ID, stamped metal ID, leash clip ID, lead clip ID, harness stamp metal ID, harness clip ID, sewn patch ID, iron branding tool ID, agricultural ear tag ID, embossed ID, etched ID, engraved ID, printed ID, electronic ID, or digital ID.

It is to be understood that the QR Scan, NFC tag, image recognition scan, barcode scan, snaptag scan code may be accompanied by visuals such as graphics 45 or icons such as paws, profile of dogs, cats, horses, and other animal graphics, images, or other type of visual indicators or references not referred to which are to be considered apparent and obvious to the disclosure. Additionally, text 60 may further accompany the QR code, NFC tag, image recognition scan, barcode scan, snaptag scan, code in the form of words, statements, names, calls to action such as “Help Me Phone Home”, Kid Friendly”, “Shy-Pet Under Chin NOT on Head” or other text based messages not referred to herein yet obvious to the disclosure.

It is also intended that the main tag body 10, in the preferred embodiment of the present invention, be manufactured using plastic materials including, resins, acrylics, polymers, plastic composites, and other materials not referred to herein which perform the same function and are to be considered apparent and obvious to the disclosure contained herein. Additional embodiments of the tags may be manufactured using a variety of metal materials including but not limited to steel, stainless steel, aluminum, copper, silver, gold, zinc, platinum, and other metals and composites thereof not referred to herein that perform the same purpose and function as the invention disclosed herein. The main tag body is further intended to comprise a hole for inserting a ring, chain, wire, string, clip or other similar fastener intended to attach the tag to the collar 11 of an animal. An alternate embodiment of the invention allows the tag to be attached or affixed to a collar slide fastener 17 having first and second openings 18 at opposing end to allow the tag 10 and collar slide fastener 17 to be removably attached to a pet collar 11.

It is to be understood that the main service website of the preferred embodiment will be developed in a manner that will allow a user to access and interface with the main service website and all associated aspects, features, and or functions of the website, from either a wired or wireless connection from a variety of electronic desktop or handheld communications devices including but not limited in use to, desktop PC, Laptop computer, handheld electronic device such as Palm Pilot, Blackberry, IPhone, IPad, cell phone, Smart PDA, smart watch, QR scanner, and other similar devices not referred to herein which can be used to access the internet and thereby access the main service website disclosed herein.

It is to be further understood that the present invention in the preferred embodiment disclosed herein can be marketed to a user in a variety of commercial options, referred to herein as “Animal Information ID” options including but not limited to “Basic Tag”, “Information Tag”, and “Dynamic Tag”, whereby each different commercial embodiment will offer varying levels of service to the user and their pet(s).

The varying levels of commercial options will further be differentiated based on the range of services user's desire of what type of interactive care service they wish to be given to their animal in their absence or if the user is otherwise unable to audibly or physically dictate care to be given to their animal at time of an emergency event. Limitations related to quantity, length, and editability of data and information points may be imposed based on the Animal Information ID option choice.

A first embodiment of an Animal Information ID option is the “Point of Sale (POS) or Simple Basic Tag” option of the preferred embodiment, which allows a user to purchase a tag, either from a physical brick and mortar retail location or an online retail location, then activate the tag, either through an online website, mobile application (APP), email, SMS, or phone in process, therein selectively accumulate, enter, store, filter, access, edit and otherwise manage the “Name” of the pet or subject animal, the “Contact” information pertaining to the owner of the pet or subject animal, and then have the QR scan code generated to be printed and inserted into a receiving slot 51 or cavity of the tag body enclosed by a removable end cap 55. In this embodiment of the invention disclosed herein, the QR scan code is not created or generated until the user has entered all relevant pet related information. Once entered, the website, APP, or other user interface can allow for the QR scan code to be saved, downloaded, and or printed for the purposes of inserting into the main tag body. This POS embodiment allows for the QR scan code to be removably inserted into the main tag body by way of inserting it into a closable or sealable slot 51, cavity, compartment, or other type of void in the main tag body that can receive the QR scan code and then be sealed closed with a removable end cap 55. This embodiment may further provide the user with the option to upload, save, and print a photo of the pet or subject animal for the purposes of being inserted into the main tag body in a manner similar to the printed QR scan code disclosed herein.

Other embodiments of the invention comprise the QR scan code as an embedded feature of the tag whereby the QR scan code is printed, etched, stamped, or otherwise permanently embedded and embodied into the main tag body prior to the POS. This POS embodiment allows for the QR scan code to be associated with a specific “Profile Template” that pre-exists on a computer server or database, and can be accessed by the user by utilizing a computing device such as a desktop, laptop, or mobile computing device to access a website wherein a user would be able to enter, edit, update or otherwise manage, data and information pertaining to one or more specific animals, as well as a person or persons associated with said animal(s). In this POS embodiment, the pre-generated QR scan code can be associated or connected to the “Profile Template” either before the POS during the manufacturing process, or after the POS whereby the user would initiate the association or connection via the “Profile Template” website. This embodiment may further provide the user with the option to upload, save, and print a photo of the pet or subject animal for the purposes of being inserted into the main tag body in a manner similar to other embodiments disclosed herein.

Point of Sale (POS) or Simple Basic Tag
QR Type: Static (non editable)
Cost:
Basic Tag Information
Pet's name
Photo:
Pet Papa Name:
Phone #
Pet Mama Name:
Phone #
QR CODE:

A second embodiment of an Animal Information ID option is the “Basic Tag” option of the preferred embodiment, which allows a user to selectively accumulate, enter, store, filter, access, edit and otherwise manage the “Name” of the pet or subject animal, the “Contact” information pertaining to the owner of the pet or subject animal, and the generated QR scan code.

Basic Tag
QR Type: Static (non editable)
Cost:
Basic Tag Information
Pet's name
Photo:
Pet Papa Name:
Phone #
Pet Mama Name:
Phone #
QR CODE:

A third embodiment of an Animal Information ID option is the “Information Tag” option of the preferred embodiment, which allows a user to selectively accumulate, enter, store, filter, access, edit and otherwise manage the Name” of the pet or subject animal, the “Contact” information pertaining to the owner of the pet or subject animal, the “Photograph” or likeness image of the pet or subject animal, and the generated QR scan code. It is to be understood that the “Photograph” or “Photo” or likeness image of the pet or subject animal, can be represented, accumulated, entered, stored, filtered, accessed, edited and otherwise managed in digital or physical form, whereby the digital form can be uploaded, changed, deleted, archived, and printed from a computer related software, software programming language and code, including computer based applications, internet web page based code, and methods of applications used in the creation of the preferred embodiment of the present invention. The “Photograph” or “Photo” or likeness image of the pet or subject animal, can also be printed into physical form on print media and applied, inserted, adhered or otherwise removably or fixedly attached to the main tag body, thereby allowing for visual confirmation that the tag and related data and information belongs to the related pet or subject animal.

Information Tag

| QR Type: | Static | (non editable) | | |
|---|---|---|---|---|
| Cost: | | | | |
| Basic Tag Information | | | | |
| Pet's name | | | | |
| Photo: | | | | |
| Pet Mama Name: | | Phone # | | |
| Pet Papa Name: | | Phone # | | |
| QR CODE: | | | | |
| Address: | | | City, State: | Zipcode: |
| Veterinarian Name: | | Phone # | | |

Rabbies Tag #
Date
Chip #:

A fourth embodiment of an Animal Information ID option is the “Dynamic Tag” option of the preferred embodiment, which allows a user to selectively accumulate, enter, store, filter, access, edit and otherwise manage the Name” of the pet or subject animal, the “Contact” information pertaining to the owner of the pet or subject animal, the “Photograph” or likeness image of the pet or subject animal, the Veterinarian or “Vet Contact” information, the “Chip” information pertaining to the pet or subject animal, the “Vaccine” or shot information pertaining to the pet or subject animal, and the generated QR scan code.

Dynamic Tag

| | | |
|---|---|---|
| QR Type: | Dynamic | (Text only: editable) |
| Cost: | | |
| Basic Tag Information | | |
| Pet's name | | |
| Photo: | | |
| Pet Mama Name: | | |
| Phone # | | |
| Pet Papa Name: | | |
| Phone # | | |
| QR CODE: | | |
| Date Created: | | |
| Address: | City, State: | |
| Veterinarian Name: | | Phone # |
| Rabbies Tag # | | |
| Date: | | |
| Chip #: | | |
| Vaccinations: | | |
| Fees to update: | | |
| Additional updates | | |
| $10.00 per update | | |
| $0.00 within first three months | | |

It is to be understood that additional embodiments of an Animal Information ID option of the preferred embodiment can be created by offering various pieces of data and information based on “service level”, “payment tier”, subscription option”, “a-la-carte” choice selection, or a wide variety of other data point or service option combinations that are considered anticipated marketing options of the present invention and are therefore to be considered apparent and obvious to the disclosure contained herein.

The present invention, in additional applications of the preferred embodiment, is intended to be used as a “Travel Accommodation Tag”, whereby the user or pet owner selects a “Travel” option, or otherwise indicates, within the pet owner's, pet or subject animal's data and information profile, travel intentions. This option or feature will collect travel related information from the user or pet owner, including but not limited to, dates of travel, origin of travel, destination of travel, duration of travel, owner transportation method of travel, transportation information of travel, animal transport method of travel, travel itinerary, reservation numbers, hotel/lodging name with phone number and other information related to travel not referred to herein which is to be considered apparent and obvious to the disclosure.

The present invention, in additional applications of the preferred embodiment, is intended to be used as a “Hotel/Public Lodging Tag”, whereby the user or pet owner selects a “Hotel” or “Public Lodging” option, or otherwise indicates, within the pet owner's, pet or subject animal's data and information profile, hotel or public lodging intentions. This option or feature will collect hotel of public lodging related information from the user or pet owner including but not limited to travel itinerary, lodging information such as dates, locations, reservation numbers, boarding information, and other information related to hotel or public lodging not referred to herein which is to be considered apparent and obvious to the disclosure.

The present invention, in another additional application of the preferred embodiment, is intended to be used and provided by the Hotel/Public Lodging entity as a “Pet Guest Tag”, whereby the Hotel/Public Lodging entity provides, to their guests who are staying with their pets, a “Pet Room ID Tag” to place on their collar during their stay. This Pet Room ID Tag provides an additional service from the lodging entity providing additional comfort and a form of security for their guest's pet(s) during their stay. In the event that the pet is lost, stolen, injured, or is otherwise in a position that is remote or removed from the pet owner, or guest of the Hotel/Public Lodging entity, and is further in need of immediate emergency care, the Pet Room ID Tag will provide responders with all relevant emergency pet related information, including but not limited to, contact phone numbers, SMS numbers, email addresses, pet treatment plan, pet medical records, pet prescription information, vet phone numbers, as well as other information and data. The Pet Room ID Tag may further allow a pet owner or guest of the Hotel/Public Lodging entity, or authorized person removed from the Hotel/Public Lodging entity, such as a service provider in a different state, to be able to track or otherwise locate the pet(s) by utilizing Global Positioning System (GPS) tracking technology embedded in the pet in the form of a chip, or embedded or removably attached to the Pet Room ID Tag, thereby allowing for the pet to be tracked and located through a website, mobile APP, or other GPS locator device or service not referred to herein that performs the same purpose and function and is to be considered apparent and obvious to the disclosure contained herein.

An alternate embodiment of the present invention comprises a QR code, NFC tag, Image recognition, barcode, or snaptag, component of the main tag body and a separate photo component that can be removably or fixedly connected together. This allows for the user to update, upgrade, modify, change, replace, or otherwise manage either of the components independently without requiring the replacement of the other. This embodiment will also allow for the commercial marketing and sale of either component individually, such as at point of purchase brick and mortar or online retail sales locations.

Another alternate embodiment of the present invention allows the QR code, NFC tag, Image recognition scan, barcode scan, snaptag scan, or similar specific data and information identifying and conveyance method, component of the invention to be commercially marketed and offered for sale at point of purchase brick and mortar or online retail sales locations, whereby the QR code, NFC tag, Image recognition scan, barcode scan, snaptag scan, or similar specific data and information identifying and conveyance method is used in combination with a second secure identifier, such as a username, password, security key, security code, or similar security method, to access a user specific, secure main services webpage, website, application (APP) page, database, data form or server, thereby allowing them to upload or enter pet related data and information, save the data and information, then access the same saved data and information at a future time by using the QR code, or similar specific data and information identifying and conveyance method, and related second secure identifier, such as a username, password, security key, security code, or similar security method not referred to herein which is to be considered apparent and obvious to the disclosure contained herein. Further, the QR code, or similar specific data and information identifying and conveyance method is intended to be embodied in a main tag body and removably attached to the pet or subject animal.

The present invention in the preferred, and alternate embodiments, will allow zoo or animal sanctuary personnel to manage, track, and care for subject animals confined to the zoo or sanctuary. This application of the invention includes the ability to manage, facilitate, organize, schedule, share, and update, feedings, medicines, vaccinations, general health care, environment cleanings, relocations, and handling and engagement safety measures and protocols as well as other tasks, data, and information related to zoo-based or sanctuary-based animals.

The present invention in the preferred, and alternate embodiments, will further allow for real-time data and information related to pets or subject animals to be collected, stored, evaluated and analyzed for insurance related purposes. This application of the invention includes the ability to collect and share data and information related to the ownership, management, location, transportation, scheduling, feeding, medical, vaccination, general health care, movement, and handling and engagement safety measures and protocols as well as other tasks, data, and information related to pets and subject animals including but not limited to, domestic pets like cats, dogs, rabbits, reptiles, birds, and others, as well as commercial animals sold in commerce such as cattle, competitive animals including but not limited to race horses, show horses, race dogs, show dogs, show cats, show cattle, show pigs and other competition animals not referred to herein.

It is to be further understood that the present invention in the preferred, and alternate embodiments, will further allow for real-time data and information related to farm and livestock animals to be collected, stored, evaluated and analyzed. This application of the invention includes the ability to collect and share data and information related to the ownership, sale, age, weight, management, location, transportation, scheduling, feeding, medical, vaccination, general health, general health care requirements, movement, and handling and engagement safety measures and protocols as well as other tasks, data, and information related to livestock processing and management.

An alternate embodiment of the invention comprises a Global Positioning System (GPS) tracker embedded within, or removably attached to, the main tag body of the invention. GPS tracking capabilities allow the real time location of a pet or subject animal to be accessed and monitored through the main service website disclosed in the preferred embodiment of the invention. This embodiment of the invention combines the ability to deliver data and information relevant to the pet or subject animal to a user who scans the tag, with the ability for the pet owner or other relevant party to remotely locate the pet or animal using the geolocation capabilities of the GPS tracking system.

Yet another alternate embodiment of the invention comprises a Radio Frequency Identification (RFID) tag or microchip embedded, inserted, or otherwise attached to the main tag body for the purposes of conveying or transmitting data and information relevant to the pet or subject animal to a user. This application eliminates the need to invasively insert the RFID tag or microchip into the pet or subject animal's body. This further allows for the tag or microchip to be changed or removed without invasive surgery. It is to be understood that the RFID device, combined with the animal information management system disclosed herein can be either passive or active to meet the desired scanning and transmitting options anticipated in the present invention. The RFID device is intended to have a transmitter and power source (typically a battery). The power source is intended to run the microchip's circuitry and to broadcast a signal to a reader such as a handheld or mobile communications device. The passive RFID tag is intended to draw power from the reader, which sends out electromagnetic waves that induce a current in the tag's antenna, thereby eliminating the need for a battery power source. Semi-passive tags may also be utilized in the invention disclosed herein, and are intended to use a battery to run the chip's circuitry, and initiate communication and thereby data and information transference by drawing power from the reader device.

The foregoing has outlined, in general, the complete detailed description of the process, and or methods of application of the invention and is to serve as an aid to better understanding the intended application and use of the invention disclosed herein. In reference to such, there is to be a clear understanding the present invention is not limited to the method or detail of process, fabrication, end use, or application of use described and illustrated herein. Any other variation of process, use, or application should be considered apparent as an alternative embodiment of the present invention.

### BRIEF DESCRIPTION OF THE DRAWINGS

The following drawings further describe by illustration the advantages and objects of the present invention.

FIG. 1. Shows a line drawing of the front side of the present invention comprising text and graphic embedded in an acrylic tag body, further comprising a hole for receiving a collar attachment ring.

FIG. 2. Shows a line drawing of the back side of the present invention comprising a QR code embedded in an acrylic tag body, further comprising a hole for receiving a collar attachment ring.

FIG. 3. Shows a line drawing of the front side of the present invention in an alternate shape, comprising text and graphic embedded in an acrylic tag body, further comprising a hole for receiving a collar attachment ring.

FIG. 4. Shows another line drawing of the back side of the present invention in an alternate shape, comprising a QR code embedded in an acrylic tag body, further comprising a hole for receiving a collar attachment ring.

FIG. 5. Shows a line drawing of the end view of the present invention comprising text and QR code embedded in an acrylic tag body, further comprising a hole for receiving a collar attachment ring.

FIG. 6. Shows a line drawing of the side view of the present invention comprising text and QR code embedded in an acrylic tag body, further comprising a hole for receiving a collar attachment ring.

FIG. 7. Shows a photo of the front sides of two different embodiments of the present invention having different shapes, comprising text and graphic embedded in an acrylic tag body, further comprising a hole for receiving a collar attachment ring.

FIG. 8. Shows a photo of the back sides of two different embodiments of the present invention having different shapes, each comprising a QR code embedded in an acrylic tag body, further comprising a hole for receiving a collar attachment ring.

FIG. 9. Shows a photo of the back sides of two different embodiments of the present invention having different shapes, each comprising a QR code embedded in an acrylic tag body, further comprising a collar attachment ring attached.

FIG. 10. Shows a photo of the front sides of two different embodiments of the present invention having different shapes, the present invention comprising a graphic, text, and QR code embedded in an acrylic tag body, further comprising a hole for receiving a collar attachment ring.

FIG. 11. Shows a photo of the front side of multiple embodiments of the present invention comprising text and pet photo embedded in an acrylic tag body, further comprising a hole for receiving a collar attachment ring.

FIG. 12. Shows a photo of another embodiment of the front side of the present invention comprising text and pet photo embedded in an acrylic tag body, further comprising a hole for receiving a collar attachment ring.

FIG. 13. Shows a photo of another embodiment of the front side of the present invention comprising text and pet photo and a QR code embedded in an acrylic tag body, further comprising a hole and a collar attachment ring.

FIG. 14. Shows a photo of the front side of the present invention with a metal tag body inserted on a collar slide fastener comprising attachment holes for receiving a collar.

FIG. 15. Shows a line drawing of the front side of the present invention with a metal tag body inserted on a collar slide fastener comprising attachment holes installed on an animal collar.

FIG. 16. Shows a line drawing of the front side of the present invention comprising text and graphic inserted in an acrylic tag body with a slot cavity and a removable end cap, further comprising a hole for receiving a collar attachment ring.

FIG. 17. Shows a line drawing of the back side of the present invention comprising a QR code inserted in an acrylic tag body with a slot cavity and a removable end cap, further comprising a hole for receiving a collar attachment ring.

FIG. 18. Shows a line drawing of the front side of the present invention in an alternate shape, comprising text and graphic inserted in an acrylic tag body with a slot cavity and a removable end cap, further comprising a hole for receiving a collar attachment ring.

FIG. 19. Shows another line drawing of the back side of the present invention in an alternate shape, comprising a QR code inserted in an acrylic tag body with a slot cavity and a removable end cap, further comprising a hole for receiving a collar attachment ring.

FIG. 20. Shows a line drawing of the end view of the present invention comprising text and QR code inserted in an acrylic tag body with a slot cavity and a removable end cap, further comprising a hole for receiving a collar attachment ring.

FIG. 21. Shows a line drawing of the side view of the present invention comprising text and QR code inserted in an acrylic tag body with a slot cavity and a removable end cap, further comprising a hole for receiving a collar attachment ring.

FIG. 22. Shows a diagram of a process flow for one embodiment of the present invention illustrating the steps from initial user to end user.

FIG. 23. Shows a listing of data and information inputs for an animal and user profile for one embodiment of the present invention illustrating the information to be entered by a user.

FIG. 24. Shows a diagram of a process flow for one embodiment of the present invention illustrating the steps from initial user, animal, animal and user profile, computer server database, second user with QR code reader, and animal with QR code tag.

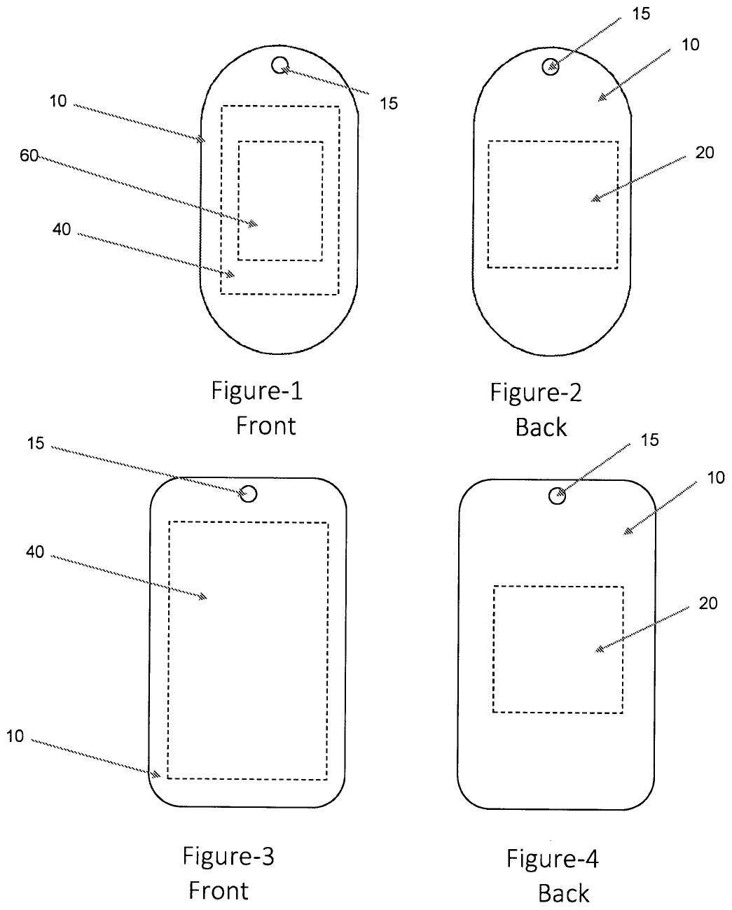

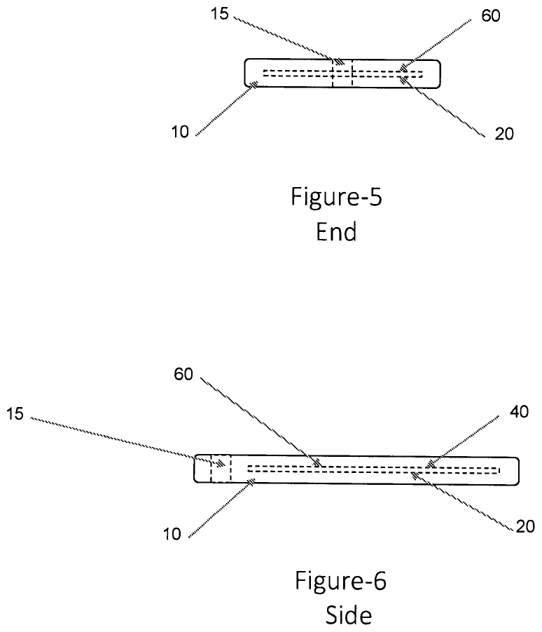

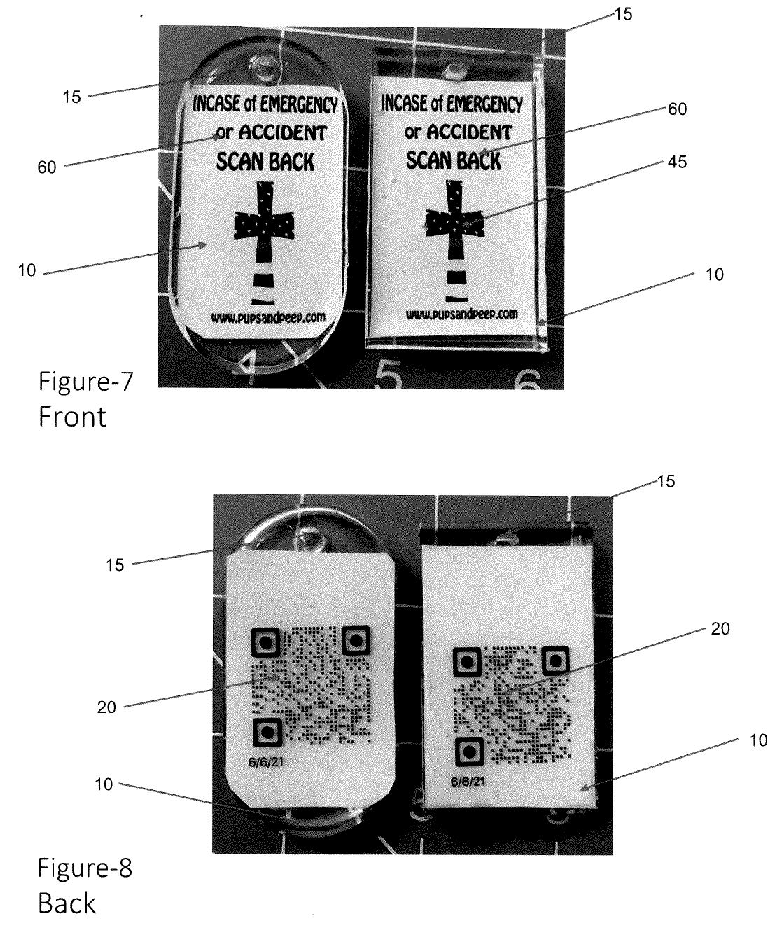

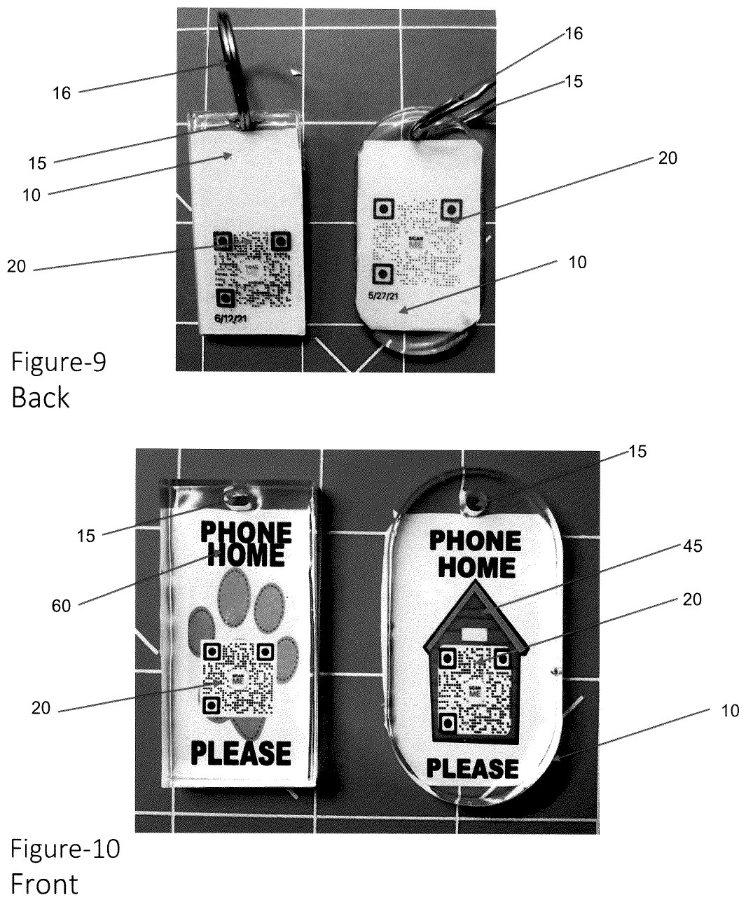

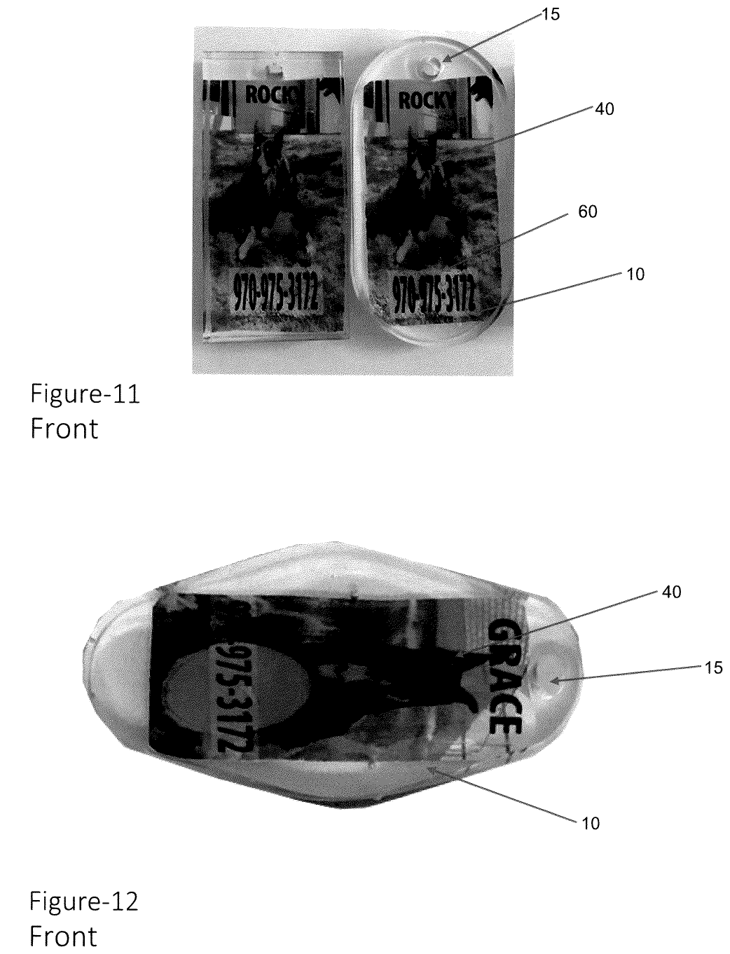

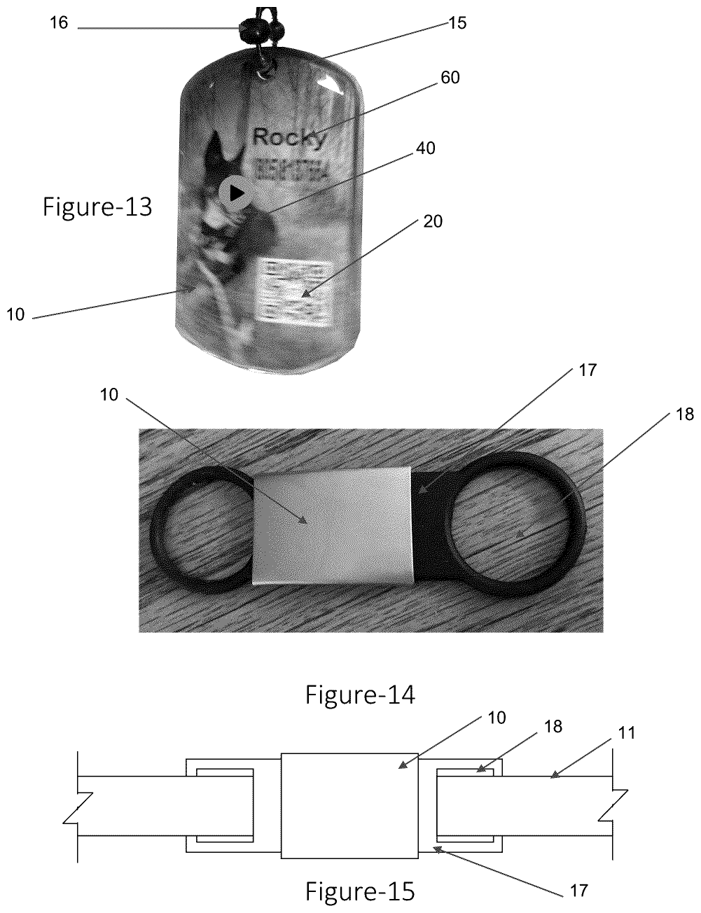

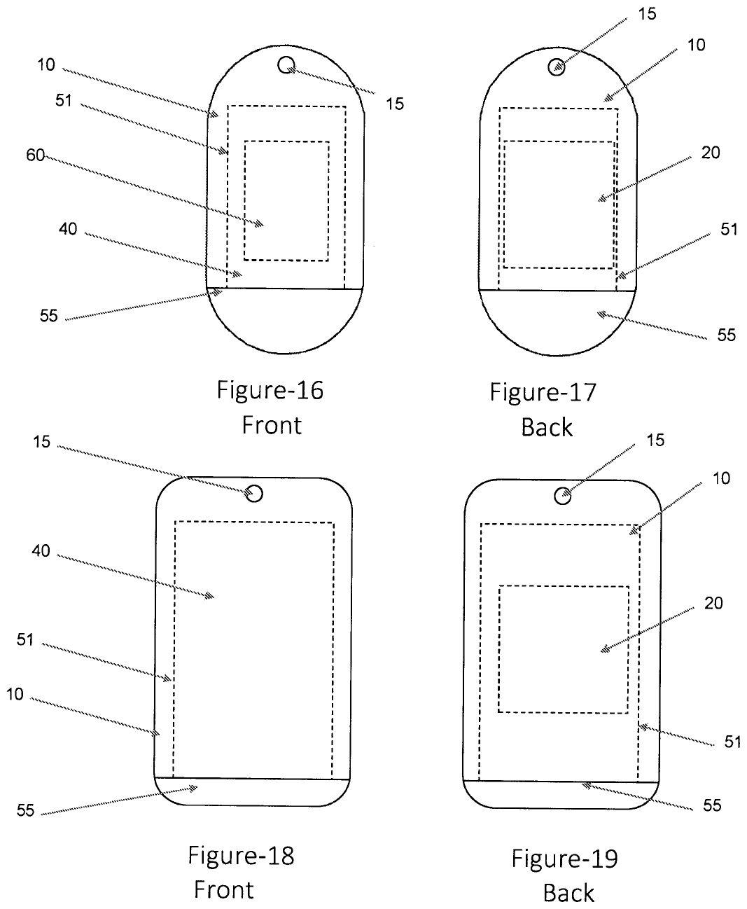

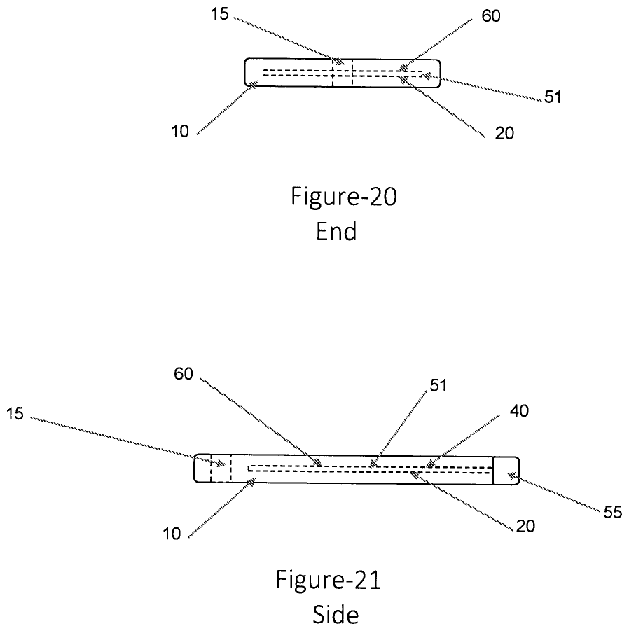

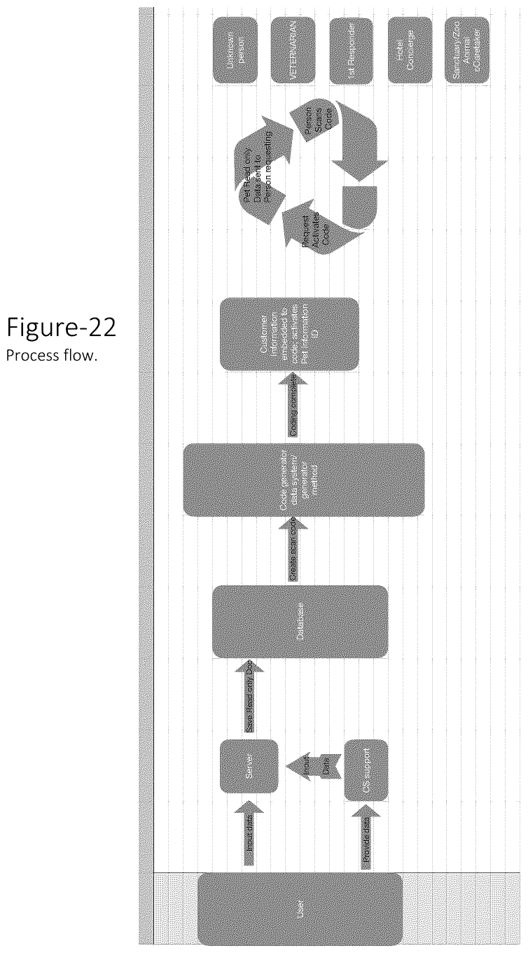

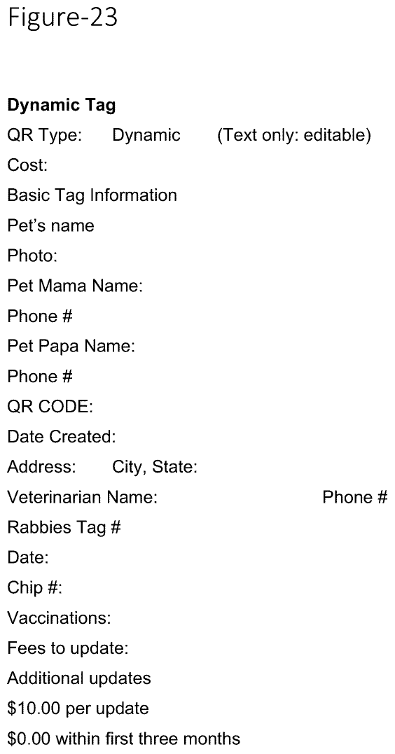

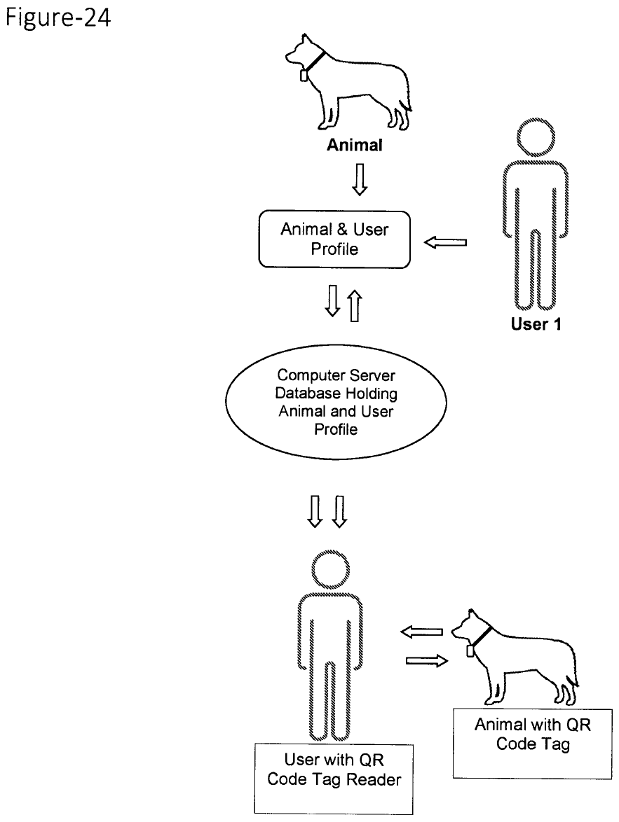

1. An animal information management system & method of use thereof, comprising: an animal identification (ID) tag, a computer server based user and animal profile, a data transfer method, and computer related software, software programming language and code, including computer based applications, internet web page based code, and methods of applications for providing the user with a method and process to facilitate and manage the various tasks associated with accumulating, correlating, organizing, saving, storing, retrieving, and disseminating or communicating digital, user and animal specific information across digital computing platforms, software applications, or communications devices; providing a user with current, vital, and relevant information and data pertaining to the identity, health, location, owner, diet, feeding schedule, care to be given, prescriptions, vaccines, emergency contacts, and other information related to a pet owner or subject animal, by way of data transfer from the tag to a computing device.

2. The animal information management system of claim 1, wherein the data transfer method is a quick response (QR) code.

3. The animal information management system of claim 2, wherein the quick response (QR) code is pre-generated and pre-associated with a user and animal “Profile Template”.

4. The animal information management system of claim 1, wherein user access to the user and animal profile and data, is subscription based.

5. The animal information management system of claim 1, wherein the data transfer method is a near field communication (NFC) sensor tag.

6. The animal information management system of claim 1, wherein the data transfer method is a barcode scan.

7. The animal information management system of claim 1, wherein the data transfer method is a snaptag image barcode scan.

8. The animal information management system of claim 1, wherein the data transfer method is an image recognition scan.
